(19) United States
(12) Patent Application Publication
(10) Pub. No.: US 2021/0182916 A1
(43) Pub. Date: Jun. 17, 2021

(54) ELECTRONIC KIOSK

(71) Applicant: b8ta, Inc., Austin, TX (US)

(72) Inventors: Vibhu Norby, Mountain View, CA (US); Phillip Raub, San Francisco, CA (US); William Mintun, Aptos, CA (US); Anton Vishnyak, San Ramon, CA (US); Joshua Brueckner, San Francisco, CA (US)

(73) Assignee: b8ta, Inc., Austin, TX (US)

(21) Appl. No.: 17/121,727

(22) Filed: Dec. 14, 2020

Related U.S. Application Data
(60) Provisional application No. 62/947,447, filed on Dec. 12, 2019.

(51) Int. Cl. G06Q 30/02; G06Q 30/06; G06Q 20/20

(52) U.S. Cl. CPC G06Q 30/0272; G06Q 20/204; G06Q 30/0641

(57) ABSTRACT

Techniques for tracking a product at a retail location, monitoring a consumer at the retail location, managing product interaction at a physical display of the retail location, managing product interaction at an electronic kiosk of the retail location, and generating attributable interest. The electronic kiosk can be implemented as a smart mirror, a customized fitting room, a photo booth, an amusement park kiosk, a tablet computer, or the like. Attributable interest can be explicit for a potential consumer, such as a profile associated with a person for whom personally identifying information is known; a persona, such as a type of person for which demographic, psychographic, behavioristic, geographic, or other information is known; or a statistical potential consumer that incorporates advertising exposure, social interest, or the like into a probability score.

### CROSS-REFERENCE TO RELATED APPLICATIONS

The present application claims priority to U.S. Provisional Patent Application Ser. No. 62/947,447 filed Dec. 12, 2019 and entitled “Electronic Kiosk,” which is incorporated by reference herein.

### BRIEF DESCRIPTION OF THE DRAWINGS

FIG. 1 depicts a diagram of an example of a system for providing retail as a service (RaaS) with an electronic kiosk.

FIG. 2 depicts a diagram of an example of a facility management system.

FIG. 3 depicts a flowchart of an example of a product flow, specifically a garment.

FIG. 4 depicts a diagram of an example a RaaS-integrated electronic kiosk.

FIG. 5 depicts a diagram of an example of an adaptive fitting room.

FIG. 6 depicts a diagram of an example of an attributable interest determination system.

FIG. 7 depicts a flowchart of an example of RaaS-integrated electronic kiosk interaction method.

### DETAILED DESCRIPTION

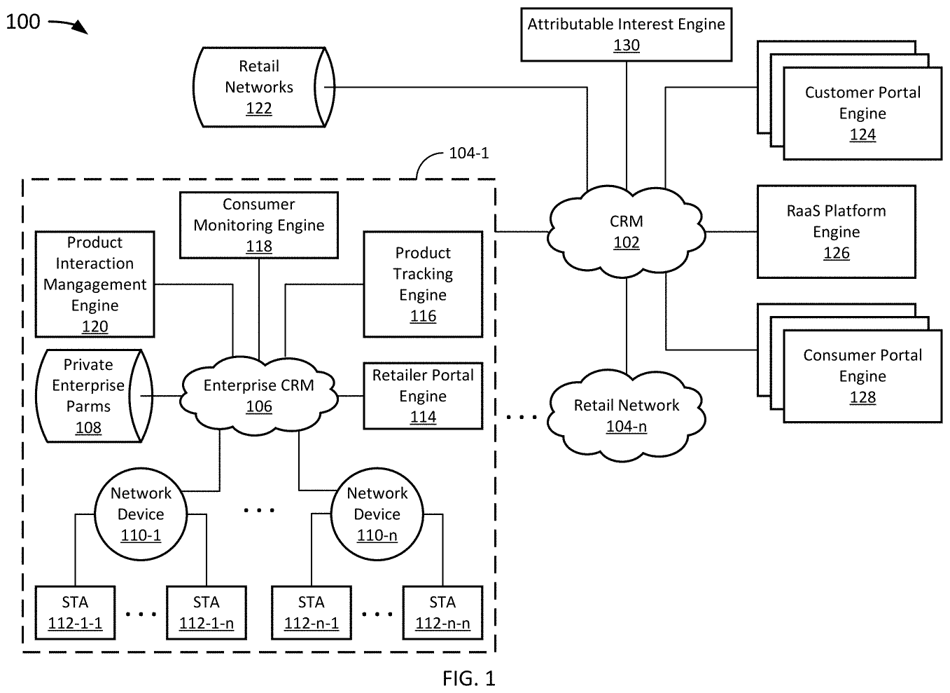

FIG. 1 depicts a diagram 100 of an example of a system for providing retail as a service (RaaS) with an electronic kiosk. The diagram 100 includes a computer-readable medium (CRM) 102, a retail network 104-1 to a retail network 104-n (collectively, the retail networks 104) coupled to the CRM 102, a retail networks datastore 122 coupled to the CRM 102, one or more customer portal engines 124 coupled to the CRM 102, a RaaS platform engine 126 coupled to the CRM 102, one or more consumer portal engines 128 coupled to the CRM 102, and an attributable interest engine 130 coupled to the CRM 102. The retail networks 104 include an enterprise CRM 106, a private enterprise parameters datastore 108 coupled to the enterprise CRM 106, a network device 110-1 to a network device 110-n (collectively, the network devices 110) coupled to the enterprise CRM 106, a station 112-1-1 to a station 112-1-n (collectively, the stations 112-1) coupled to the network device 110-1 and a station 112-n-1 to a station 112-n-n (collectively, the stations 112-n) coupled to the network device 110-n (the stations 112-1 to 112-n can be referred to collectively as the stations 112), a retailer portal engine 114 coupled to the enterprise CRM 106, a product tracking engine 116 coupled to the enterprise CRM 106, a consumer monitoring engine 118 coupled to the enterprise CRM 106, and a product interaction management engine 120 coupled to the enterprise CRM 106.

The CRM 102 may comprise a computer system or network of computer systems. A “computer system,” as used herein, may include or be implemented as a specific purpose computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

Memory of a computer system includes, by way of example but not limitation, random access memory (RAM), such as dynamic RAM (DRAM) and static RAM (SRAM). The memory can be local, remote, or distributed. Non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. During execution of software, some of this data is often written, by a direct memory access process, into memory by way of a bus coupled to non-volatile storage. Non-volatile storage can be local, remote, or distributed, but is optional because systems can be created with all applicable data available in memory.

Software in a computer system is typically stored in non-volatile storage. Indeed, for large programs, it may not even be possible to store the entire program in memory. For software to run, if necessary, it is moved to a computer-readable location appropriate for processing, and for illustrative purposes in this paper, that location is referred to as memory. Even when software is moved to memory for execution, a processor will typically make use of hardware registers to store values associated with the software, and a local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus of a computer system can couple a processor to an interface. Interfaces facilitate the coupling of devices and computer systems. Interfaces can be for input and/or output (I/O) devices, modems, or networks. I/O devices can include, by way of example but not limitation, a keyboard, a mouse or other pointing device, disk drives, printers, a scanner, and other I/O devices, including a display device. Display devices can include, by way of example but not limitation, a cathode ray tube (CRT), liquid crystal display (LCD), or some other applicable known or convenient display device. Modems can include, by way of example but not limitation, an analog modem, an IDSN modem, a cable modem, and other modems. Network interfaces can include, by way of example but not limitation, a token ring interface, a satellite transmission interface (e.g. “direct PC”), or other network interface for coupling a first computer system to a second computer system. An interface can be considered part of a device or computer system.

Computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes at least two components: 1) a dedicated or shared processor or a portion thereof; 2) hardware, firmware, and/or software modules executed by the processor. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized, or its functionality distributed. An engine can include hardware, firmware, or software embodied in a computer-readable medium for execution by the processor. The processor transforms data into new data using implemented data structures and methods, such as is described with reference to the figures in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

Assuming a CRM includes a network, the network can be an applicable communications network, such as the Internet or an infrastructure network. The term “Internet” as used in this paper refers to a network of networks that use certain protocols, such as the TCP/IP protocol, and possibly other protocols, such as the hypertext transfer protocol (HTTP) for hypertext markup language (HTML) documents that make up the World Wide Web (“the web”). More generally, a network can include, for example, a wide area network (WAN), metropolitan area network (MAN), campus area network (CAN), or local area network (LAN), but the network could at least theoretically be of an applicable size or characterized in some other fashion (e.g., personal area network (PAN) or home area network (HAN), to name a couple of alternatives). Networks can include enterprise private networks and virtual private networks (collectively, private networks). As the name suggests, private networks are under the control of a single entity. Private networks can include a head office and optional regional offices (collectively, offices). Many offices enable remote users to connect to the private network offices via some other network, such as the Internet.

The retail networks 104 are intended to represent private networks on the CRM 102, which is intended to represent a WAN. The enterprise CRM 106 is intended to represent a CRM that is under the control of an enterprise and, in this specific example, a retail enterprise.

The private enterprise parameters datastore 108 is intended to represent data that is not shared with entities outside the enterprise. The data need not rise to the level of a trade secret, but may include data associated with devices, traffic, users, and other data that is not shared or is shared on a limited basis with other parties. At least for illustrative purposes, the private enterprise parameters datastore 108 includes enterprise geographic, enterprise organizational, and enterprise network data.

The network devices 110 are intended to represent routers, switches, access points, gateways, including wireless gateways, repeaters, or any combinations thereof. In functioning as gateways, network devices can transport data from a backend of a network to a device coupled to the network devices. In functioning as access points, network devices can couple a device coupled to the network devices to a network associated with the network devices. In a specific implementation, at least one of the network devices 110 is a wireless access point (WAP). In an 802.11-compliant implementation, a WAP is a networking hardware device that allows a wireless device to connect to a backbone network in compliance with the IEEE 802.11 standard. IEEE 802.11a-1999, IEEE 802.11b-1999, IEEE 802.11g-2003, IEEE 802.11-2007, and IEEE 802.11n TGn Draft 8.0 (2009) are incorporated by reference. In alternative embodiments, one or more of the network devices 110 may comply with a different standard other than IEEE 802.11, such as Bluetooth and ZigBee.

IEEE 802.3 is a working group and a collection of IEEE standards produced by the working group defining the physical layer and data link layer's MAC of wired Ethernet. This is generally a local area network technology with some wide area network applications. Physical connections are typically made between nodes and/or infrastructure devices (hubs, switches, routers) by various types of copper or fiber cable. IEEE 802.3 is a technology that supports the IEEE 802.1 network architecture. As is well-known in the relevant art, IEEE 802.11 is a working group and collection of standards for implementing wireless local area network (WLAN) computer communication in the 2.4, 3.6 and 5 GHz frequency bands. The base version of the standard IEEE 802.11-2007 has had subsequent amendments. These standards provide the basis for wireless network products using the Wi-Fi brand. IEEE 802.1 and 802.3 are incorporated by reference. Wi-Fi is a non-technical description that is generally correlated with the IEEE 802.11 standards, as well as Wi-Fi Protected Access (WPA) and WPA2 security standards, and the Extensible Authentication Protocol (EAP) standard.

The stations 112 are intended to represent wireless devices. In a specific implementation, a wireless device is a thin client device or an ultra-thin client device that includes a wireless network interface, through which the wireless device can receive data wirelessly through a wireless communication channel. The wireless network interface can be used to send data generated by the wireless device to remote or local systems, servers, engines, or datastores through a wireless communication channel. In a specific example, the wireless communication channel is a cellular communication channel. In an 802.11-compatible or 802.11-compliant implementation, a wireless device is 802.11 standards-compatible or 802.11 standards-compliant. As used in this paper, a system or device that is 802.11 standards-compatible or 802.11 standards-compliant complies with at least some of one or more of the incorporated documents' requirements and/or recommendations, or requirements and/or recommendations from earlier drafts of the documents and includes Wi-Fi systems. The stations 112 can be referred to as “on” a wireless network of an enterprise network but may or may not be the property of the enterprise. For example, the stations 112 could include privately owned devices that access services through a guest or other network of an enterprise network, or IoT devices owned by the enterprise that are on a wireless network of the enterprise.

In the example of FIG. 1, the network devices 110 are depicted with the stations 112 but it should be understood not all network devices have stations.

The retailer portal engine 114 is intended to represent an engine that enables human or artificial agents of the retail networks 104 to provide information about their enterprises and to receive informational and administrative support via an agent of the RaaS platform engine 126. Advantageously, the information includes that provided by an agent of the RaaS platform engine 126.

The product tracking engine 116 is intended to represent an engine that tracks a location of a product in a facility. The product tracking engine 116 can be part of a facility management system associated with operation of the facility. In a specific implementation, a facility includes a physical facility. A “physical facility,” as used herein, may refer to any area that can be configured to support retail activity. “Retail activity,” as used herein, may refer to the transfer of items in a “brick-and-mortar” location for consideration. Retail activity may include sale of items, barter of items, or transfer of items to consumers that results in remuneration. A facility can include a dedicated retail space, such as a store in a mall, shopping district, etc. A retailer can have multiple facilities. In various implementations, the facility includes a building, a courtyard, an event center, an airport or travel facility, or some combination thereof. The facility can also include a portion of a building, a courtyard, an event center, an airport or travel facility, etc. In some implementations, the facility is dedicated to a single retailer. In various implementations, the facility may be shared by a plurality of retailers. A facility operator can be an entity that is distinct from entities that control other aspects of a RaaS system. For example, the facility operator can white label a RaaS system that is controlled in substantial part by a distinct RaaS provider.

In a specific implementation, a facility includes fixtures, staff, products for sale in the facility, facility monitoring devices, facility operations devices, and in-facility display devices (including display devices for products that are displayed in-store, but are purchasable through another channel, such as the Internet). Fixtures may include plumbing fixtures, electrical fixtures, kitchen fixtures, light fixtures, and/or other fixtures. Staff may include one or more persons who work at the facility, such as employees, contactors, or other individuals at the facility. Products may include retail items, such as clothing, books, toys, sporting goods, food, consumer electronics, etc.

The consumer monitoring engine 118 is intended to represent an engine that detects physical presence of a consumer and, to the extent the system is configured to retain data about a consumer, retains demographic, geographic, psychographic, behavioristic, or other data about the consumer. In some instances, consumer information is represented as a statistic, such as traffic into a store, traffic near a product, predicted exposure to an advertisement, or the like. In other instances, consumer information can be represented as detected data points, such as presence in a store (and a path taken through a store), interaction with products, detectable demographic data, or the like, though retailers will have a privacy policy to which data collection techniques must adhere. In other instances, consumer information can be represented as provided data points, such as voluntary association with a network device via a smartphone, using an app associated with the retailer, being a member of a consumer rewards program, or the like. In some instances, generic consumer data can be retained and only associated with a specific consumer when the consumer becomes known, such as at a point of sale. For example, a consumer's path through a store may not include any personally identifiable information but upon providing credit card information, the consumer's path can be associated with a product purchase.

In a specific implementation, a consumer is tracked using an RFID tag that is unique to the consumer. For example, a consumer could be offered a membership card with an RFID as part of a consumer incentive program. Consumers could also be offered a guest RFID card for anonymous but trackable use. Preferences can be associated with a consumer when the consumer is known. For example, a consumer may have an account with a consumer profile that includes explicit preferences or demographic, geographic, psychographic, or behavioristic (in particular, previous purchases) data that indicate implicit preferences, that can be used to guide consumer service providers making recommendations or customize display or recommendation parameters at a physical display or electronic kiosk when the consumer is nearby. A consumer profile can be updated over time, such as when a consumer electronically sends a basket to an associated profile to be opened later for consideration (e.g., via a QR code), potentially including “opening” the basket at an electronic kiosk and having a customer associate bring the contents of the basket to the electronic kiosk for consideration, thereby enabling a consumer to add items to a cart without actually pushing a cart around.

The product interaction management engine 120 is intended to represent an engine that manages, which can include monitoring and/or controlling aspects of a fixed location within a facility. In a specific implementation, the product interaction management engine 120 1) configures and monitors a physical display within a facility according to instructions from a customer, facility operator, store owner, or RaaS agent and 2) configures and monitors a fixed location for customized interaction with a product that is different from the physical display. The fixed location can include a dressing room, kiosk, smart mirror, or some other location to which a product may be moved for comparison, evaluation, or the like. The product interaction management engine 120 can be part of a facility management system associated with operation of the facility.

Any interaction with a product can (if detected) cause the product to be associated with the consumer. Because there can be additional associations, such as a product is associated with Taylor Swift because she wore it, the same product is associated with a consumer because of an interaction, and the consumer is associated with Taylor Swift because of a “like” in a social network, associations can have a strength that depends upon various parameters, such as linger, related product interest, similar associations, or the like. Associations can also be via demographic or other factors, such as a specific type of pants is popular with young girls, a specific type of pants is popular in a geographic location, or the like. Some interactions may trigger an event, such as if a consumer takes a product to a fitting room, they are automatically entered into a contest. Interactions and associations can be shared socially (e.g., by taking a picture, sharing a basket, using a hash tag, or the like), with a brand owner, with a retailer, or the like. In a specific implementation, a product interaction management engine can display products bought by friends or celebrities for comparison, provide videos or reviews of products, or provide other information within the limits of the capabilities of the product interaction management engine and the amount of information known about the consumer.

The retail networks datastore 122 is intended to represent a datastore that includes data structures representative of real-world resources at the retail networks 104. The information available in association with an enterprise network is implementation- and/or configuration-specific, but for illustrative purposes is assumed to include knowledge of geography, organizational elements of an enterprise, network capabilities, information associated with products offered at a fixed location of the enterprise, and information associated with other products. The data can include information explicitly entered by a human or artificial agent of an enterprise, such as addresses, business information, devices, and network protocols. The data can include third party analytics from providers of maps, device white papers, government databases, business databases, news sources, social media, or the like. The data can also be obtained from monitoring network traffic, device utilization, localized human activity, or the like.

The customer portal engines 124 are intended to represent engines and datastores that enable a product producer or distributor to establish a business relationship with a retailer. While the terms product and brand can sometimes be used interchangeably in certain contexts, a brand is intellectual property and, accordingly, does not physically exist. Every product has an associated brand even if that brand is not registered or even acknowledged. As used in this paper, a customer is intended to mean an entity with one or more products that have been onboarded into a RaaS system; prior to onboarding, the entity can be referred to as a lead or a potential customer. As used in this paper, a retailer is intended to mean the owner of a space where the products of a customer can be displayed. Customers and retailers can include a number of human and artificial agents and, in some instances, can be a combination of distinct entities (e.g., a mall landlord could control some aspects of a RaaS system, while a store owner within the mall could control other aspects of the RaaS system).

The RaaS platform engine 126 is intended to represent engines and datastores for taking data from various systems of a RaaS system, sharing with subsystems of the RaaS system in real time, and performing analytics on behalf of at least a customer and retailer. Advantageously, analytics can be provided on a per-product, per-display, per-facility, per-variation (e.g., by color), to name a few bases. With respect to a per-display basis, it is also possible to predict performance based upon path and heat maps for a potential display location (potentially even if the display location does not exist until facility layout is changed). Analytics can also be provided for a product against a category (e.g., a smart watch compared to other smart watch brands).

The consumer portal engines 128 are intended to represent engines and datastores that enable a product purchaser to interact with a brand, location, event, person, or other thing associated with a product that was purchased or is being or was considered for purchase.

The attributable interest engine 130 is intended to represent an engine that considers at least data from the retail networks 122 to determine factors that can be attributed to consumer interest in a product. Access to consumer data can provide relatively predictive interest attribution. For example, determining an ad was observed by a consumer for a product and the consumer then went to a retail outlet to purchase the product can suggest attributable interest can be ascribed at least in part to the ad. This and other stimuli can be characterized as attributable interest prior to a consumer reaching a retail location. Other attributable interest can be characterized as on-site interest generation, such as can be found in signs that indicate a product is available at a retail location, visible to consumers at the retail location. An aspect of attributable interest in a product described previously in this paper is found in the intersection between a consumer and the product, which includes what in this paper is referred to as an “interaction” by the consumer with the product. Attributable interest generally does not come from stimuli that follow acquisition of the product by the consumer but the consumer can be responsible for attributable interest on another consumer if they post their purchase online or wear or use a product in public (though it may be difficult to properly attribute interest if the amount of use, and where, is unknown).

In the example of FIG. 1, in operation, the retail network 104 join a RaaS platform by, for example, connecting to a RaaS platform engine 126 via the retailer portal engine 114. Customer portal engines 124 are also connected to the RaaS platform to integrate a customer into a RaaS platform. For example, a customer could submit a product description and product code that a retailer can integrate into Point-of-Sale (PoS) systems, inventory systems, e-commerce systems. Other brand onboarding data can include catalogs or catalog entries, signage requirements, an executable component (an application, a process, an executable portion of a web browser, etc.) that receives instructions from retailers to identify available facilities and parameters associated therewith (e.g., location, timeline, rental cost, rental space, etc.), which a customer can use for making brand onboarding decisions, or the like.

The products of one or more customers associated with the customer portal engines 124 are provided to one or more physical retail locations associated with the retail networks 104. A consumer at a retail location can interact with a product at a physical display, the physical display being managed by the physical display engine 116. If the product is of sufficient interest, the customer can take the product itself or call for the product (or similar product) to be taken to a physical location managed by the product interaction management engine 120. The private enterprise parameters datastore 108 stores all data that can be captured in association with the product, whether at sensors (implemented in one or more of the stations 112 or in other devices) when detecting activity at the retail location, at network devices (that may or may not have associated stations) that capture state associated with the retail networks 104, or at network devices that access data via the CRM 102.

A subset of the private enterprise parameters datastore 108 content is provided to (or can be characterized as) the retail networks datastore 122. The RaaS platform engine 126 can access the retail networks datastore 122 to learn about the retail networks 104. The customer portal engines 124 can access the retail networks datastore 122 to learn about brand performance and other data related to products provided by respective customers at applicable retailers, potentially including general information that enables consideration of multiple retailers in the aggregate without access to some of the data available in association with a specific retailer, or with anonymized information.

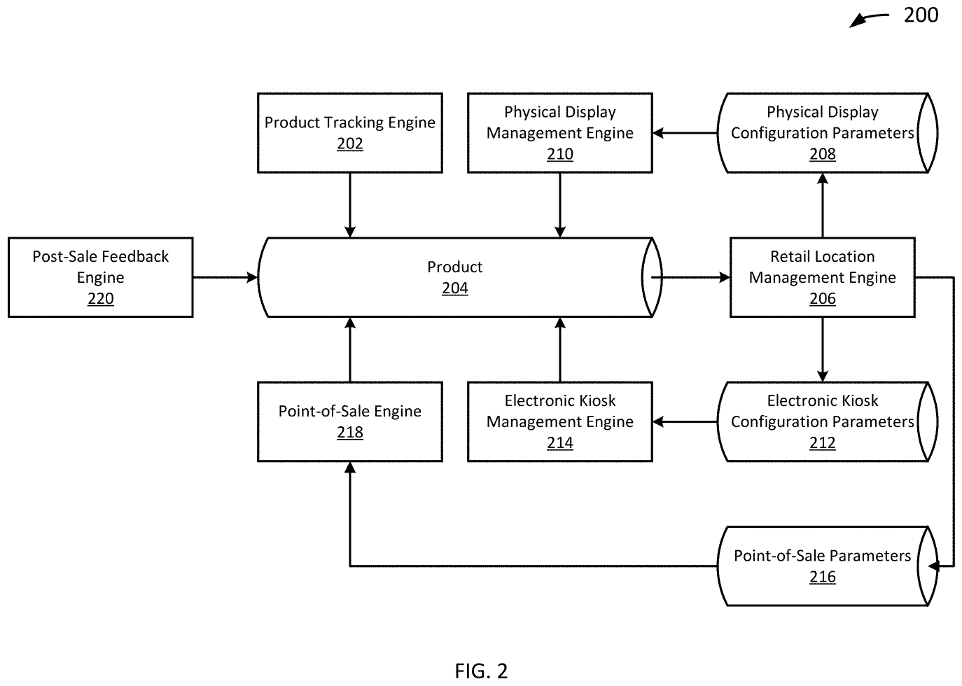

FIG. 2 depicts a diagram 200 of an example of a facility management system. The diagram 200 includes a product tracking engine 202, a product datastore 204 coupled to the product tracking engine 202, a retail location management engine 206 coupled to the product datastore 204, a physical display configuration parameters datastore 208 coupled to the retail location management engine 206, a physical display management engine 210 coupled to the physical display configuration parameters datastore 208 and the product datastore 204, an electronic kiosk configuration parameters datastore 212 coupled to the retail location management engine 206, an electronic kiosk management engine 214 coupled to the electronic kiosk configuration parameters datastore 212 and the product datastore 204, a point-of-sale (PoS) parameters datastore 216 coupled to the retail location management engine 206, a PoS engine 218 coupled to the PoS parameters datastore 216 and the product datastore 204, and a post-sale feedback engine 220 coupled to the product datastore 204.

The product tracking engine 202 is intended to represent an engine that includes one or more sensors for detecting a product instance. In a specific implementation, when a product instance is detected, data associated with the product instance is stored in the product datastore 204, which may or may not be initialized with data associated with an instantiated product class (e.g., brand, manufacturer, price, or the like). Where precision is desired, a product instance refers to a specific physical instance of a product while a product class refers to fungible units that can be purchased by multiple consumers and referred to as the same “product.” When precision is not necessary, a product can refer to a specific instance of a product or multiple commercially identical products referred to as the same “product.” The product tracking engine 202 can continue to operate and update the product datastore 204 in parallel or intermittently with the operation of other engines described with reference to the example of FIG. 2.

The product datastore 204 is intended to represent a datastore that includes both product class data and product instance data. Product class data can include brand, manufacturer, price, and other data associated with a product. Product instance data can include a serial number for a specific product instance, a location, an RFID, or the like.

The retail location management engine 206 is intended to represent an engine that manages a physical display, an electronic kiosk, and a PoS. In a specific implementation, the retail location management engine 206 can manage a retail location in other ways, including managing work schedules, lighting, vendor management, or the like. In managing a physical display, the retail location management engine 206 stores physical display configuration parameters in the physical display configuration parameters datastore 208.

The physical display management engine 210 is intended to represent an engine that causes a physical display to operate in accordance with physical display configuration parameters in the physical display configuration parameters datastore 208. In a specific implementation, data associated with the physical display, including sensor data that detects stimuli around the physical display, are stored in the product datastore 204 in association with the applicable product (e.g., product class, product instance, or both).

In managing an electronic kiosk, the retail location management engine 206 stores electronic kiosk configuration parameters in the electronic kiosk configuration parameters datastore 212. The electronic kiosk management engine 214 is intended to represent an engine that causes an electronic kiosk to operate in accordance with electronic kiosk configuration parameters in the electronic kiosk configuration parameters datastore 212. An electronic kiosk can be implemented as a smart mirror, a customized fitting room, a photo booth, an amusement park kiosk, a tablet computer, or the like. In a specific implementation, the electronic kiosk is integrated into a RaaS package and at least some aspect of the electronic kiosk is provided by the RaaS provider. In a specific implementation, data associated with the electronic kiosk, including sensor data from electronic kiosk sensors, are stored in the product datastore 204 in association with the applicable product (e.g., product class, product instance, or both).

In managing a PoS, the retail location management engine 206 stores PoS parameters in the PoS parameters datastore 216. The PoS engine 218 is intended to represent an engine that causes a PoS to operate in accordance with PoS parameters in the PoS parameters datastore 216. In a specific implementation, data associated with the PoS, including sensor data that detects stimuli at the PoS, are stored in the product datastore 204 in association with the applicable product (e.g., product class, product instance, or both).

The post-sale feedback engine 220 is intended to represent an engine that accesses data associated with a product instance that has been sold. At a minimum, post-sale feedback will include an indication as to whether a product instance has been returned after purchase. In a specific implementation, other feedback is available via registration, consumer awards programs, social media posts or attributable “likes,” or the like.

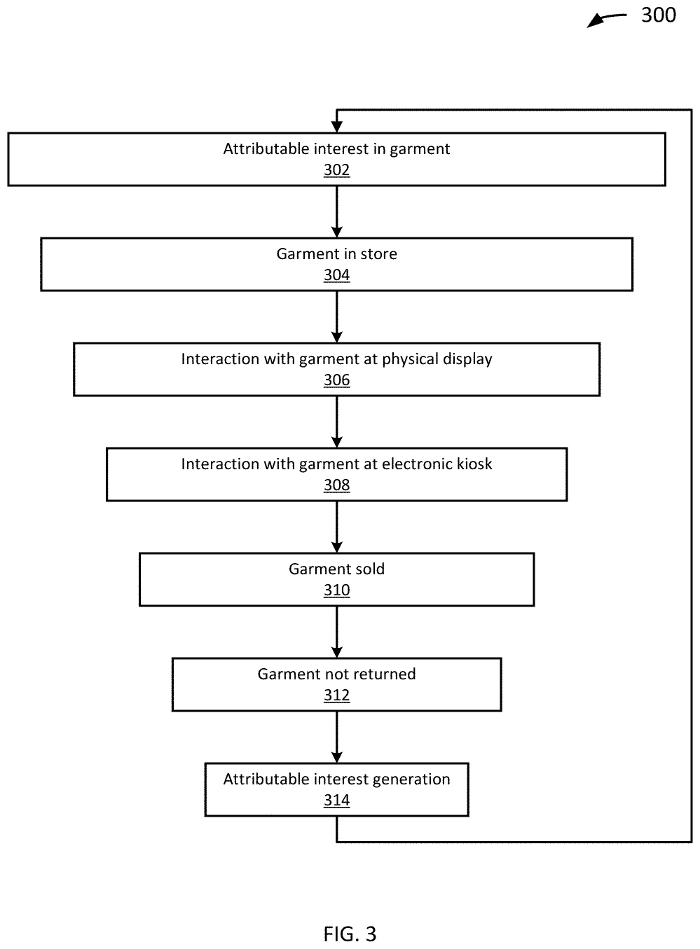

FIG. 3 depicts a flowchart 300 of an example of a product flow, specifically a garment. The flowchart 300 starts at module 302 with attributable interest in a garment. Attributable interest can be explicit for a potential consumer, such as a profile associated with a person for whom personally identifying information (PII) is known; a persona, such as a type of person for which demographic, psychographic, behavioristic, geographic, or other information is known; or a statistical potential consumer that incorporates advertising exposure, social interest, or the like into a probability score.

The flowchart 300 continues to module 304 with a garment in a store. In a specific implementation, the garment is tracked via an inventory system and may or may also include a product tracking system that includes sensors configured to determine a location of the garment continuously or intermittently within a location (e.g., within the store). Statistical “interaction” with a garment can be detected with sensors relatively remote from the garment that evaluate, for example, consumer traffic flow into or within a store. Later explicit interaction with the garment can be associated with traffic flow statistics after direct interaction with the garment is detected.

The flowchart 300 continues to module 306 with interaction with the garment at a physical display. In a specific implementation, the garment is placed at a physical display that has sensors capable of detecting interaction with the garment or a display garment (where the garment that is for sale is stored elsewhere and provided for evaluation in a fitting room and/or for purchase at a PoS). Interaction with a garment at a physical display can include tapping a display, lingering at a display, facing the display, manipulating the garment, or the like.

The flowchart 300 continues to module 308 with interaction with the garment at an electronic kiosk. In a specific implementation, the electronic kiosk includes displays and sensors, as described in more detail elsewhere in this paper. An example of an electronic kiosk is a fitting room to which a consumer takes the garment. Other products taken by a potential consumer to the electronic kiosk along with the garment can be detected, as well. In this way, it is possible to determine which product classes (including colors, sizes, or the like) tend to go together and, later, get purchased together. Electronic kiosk parameters, such as media, lighting, and the like, can also be statistically attributable to a consumer's decision to purchase the garment.

The flowchart 300 continues to module 310 with the garment being sold. In a specific implementation, the garment is taken by a potential consumer to a PoS, though an alternative garment could be taken to the PoS by the potential consumer or an agent of the retail location, or the consumer could purchase the garment via mobile commerce with a smartphone, ordered for delivery using a smartphone, or ordered for delivery at the PoS. It is at this point, typically with consumer consent, the garment can be directly linked to a specific profile representative of the consumer, which may include PII as well as demographic, psychographic, behavioristic, and/or geographic information (defining a persona).

The flowchart 300 continues to module 312 with the garment not being returned. A successful sale is generally considered one that does not result in a return for a refund. In some instances, a garment can be returned to be replaced with a similar product (e.g., the same product class in a different color or size) or replaced with a different product, both of which can result in useful information about consumer preferences.

The flowchart 300 continues to module 314 with attributable interest generation. If the consumer can be tracked online, either explicitly or statistically, interest that is attributable to the purchase can be learned. For example, if a consumer “likes” the garment in social media, the garment is tagged in a photograph of the consumer, or the like, interest in the garment by other potential consumers could be attributed to the consumer, either explicitly or statistically. The flowchart 300 then returns to module 302 and continues as described previously for a new potential consumer and garment.

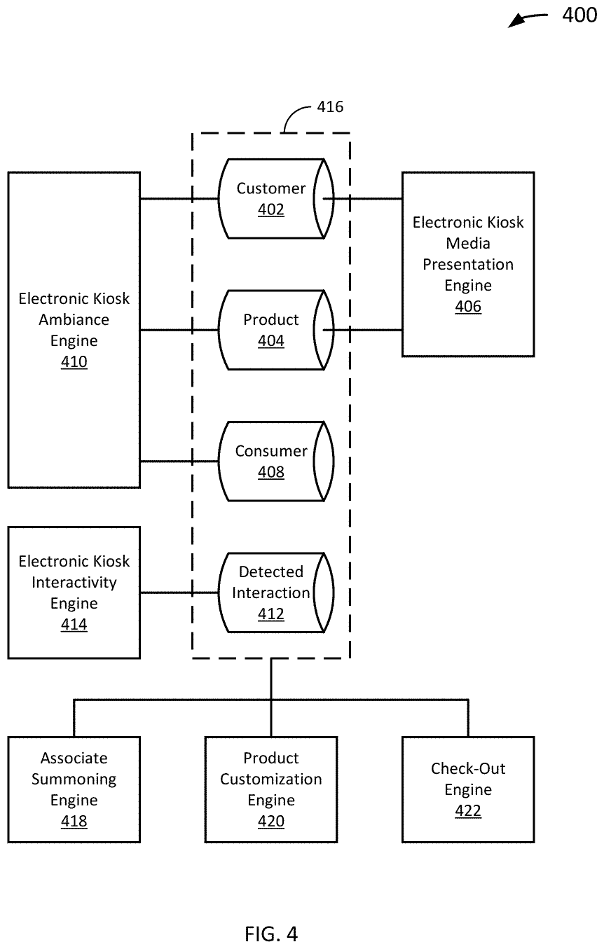

FIG. 4 depicts a diagram 400 of an example a RaaS-integrated electronic kiosk. The diagram 400 includes a customer datastore 402; product datastore 404; an electronic kiosk media presentation engine 406 coupled to the customer datastore 402 and the product datastore 404; a consumer datastore 408; an electronic kiosk ambiance engine 410 coupled to the customer datastore 402, the product datastore 404, and the consumer datastore 408; a detected interaction datastore 412; an electronic kiosk interactivity engine 414 coupled to the detected interaction datastore 412. The customer datastore 402, the product datastore 404, the consumer datastore 408, and the detected interaction datastore 412 can be collectively referred to as the electronic kiosk datastore 416. The diagram 400 further includes an associate summoning engine 418, a product customization engine 420, and a check out engine 422, each of which are coupled to the electronic kiosk datastore 416.

The customer datastore 402 is intended to represent a datastore of content associated with a retailer, landlord, or other entity that is responsible for renting, leasing, maintaining, or otherwise managing the physical location in which the electronic kiosk is found. In a specific implementation, the customer is a retailer but the customer datastore 402 can be considered to include an aggregate of information from all entities associated with the physical space, including virtual and physical spaces associated therewith (e.g., for a retailer, other retail locations or an online location of the retailer, or, for a landlord, other stores in a shopping area or an online location associated with the shopping area, to give two examples).

The product datastore 404 is intended to represent a datastore of content associated with brands. In a specific implementation, the product datastore 404 includes a brand that is made available to a consumer at an electronic kiosk and other associated brands.

The electronic kiosk media presentation engine 406 is intended to represent an engine for presenting content from the customer datastore 402 and the product datastore 404 in an electronic kiosk. In a specific implementation, content associated with a product is presented in accordance with parameters to which a customer (retailer) and brand owner have agreed.

The consumer datastore 408 is intended to represent a datastore of content provided by or derived from data associated with a consumer. In a specific implementation, the consumer datastore 406 includes content uploaded from a device of a consumer or downloaded from a location identified by the consumer. To the extent geographic, demographic, psychographic, or behavioristic data of the consumer is available, content appropriate for the consumer's profile can also be downloaded. (Note: The geographic information of an electronic kiosk can be used, as well, but the geographic data of the consumer is not necessarily the same as the location of the electronic kiosk.)

The electronic kiosk ambiance engine 410 is intended to represent an engine for providing ambiance at an electronic kiosk that is (or is derived from) content in the product datastore 404 and the consumer datastore 408. In an alternative, the electronic kiosk ambiance engine 410 could also utilize the customer datastore 402. In a specific implementation, the electronic kiosk ambiance engine 410 provides music, lighting, and other audio or visual effects to the electronic kiosk experience, as provided by a product owner (or agent thereof) and in accordance with preferences (or presumed preferences) of a consumer.

The detected interaction datastore 412 is intended to represent a datastore of detected interactions by a consumer at an electronic kiosk. In a specific implementation, the detected interactions are derived from stimuli detected by sensors at the electronic kiosk and mapped to a type of interaction. Depending upon the type of sensors used, many stimuli may be ignored for failing to be mapped to a type of interaction. For example, a microphone may pick up many different sounds, only some of which are associated with a verbal command.

The electronic kiosk interactivity engine 414 is intended to represent an engine for interpreting detected stimuli as efforts to interact with the electronic kiosk by a consumer and storing detected interactions in the detected interactions datastore 412. In a specific implementation, the electronic kiosk interactivity engine 414 includes a personal device of a consumer (on which an app is potentially installed) with which the consumer can interact, motion detection sensors at the electronic kiosk that can detect movement by the consumer, microphones at the electronic kiosk that can detect sounds made by the consumer, buttons or other input devices at the electronic kiosk that can be activated by the consumer, or the like.

The associate summoning engine 418 is intended to represent an engine through which a consumer at an electronic kiosk can summon a customer associate. In a specific implementation, the customer associate is an employee of a retailer in which the electronic kiosk is located. In an alternative, the customer associate is a human or artificial agent of an applicable entity. The customer associate can provide services such as bringing or taking away products provided at retail, such as articles that have been tried on but shall not be purchased or alternative sizes or products to be tried on, providing refreshments, offering suggestions, or the like. The customer associate can be summoned with a detected interaction, in accordance with customer or consumer preferences, or in accordance with a schedule associated with a product with which the consumer is interacting or has interacted. Interaction with a customer associate can also be recorded in a relevant datastore for determining customer associate effectiveness or for other purposes.

The product customization engine 420 is intended to represent an engine that updates product parameters in a consumer datastore in accordance with explicit, implicit, or assumed consumer preferences. Explicit consumer preferences can be derived from detected interactions by the consumer, such as an indication that a consumer likes a particular product, or from pre-entered preferences, such as an indication that a consumer is looking for a specific brand. Implicit consumer preferences can also be derived from detected interactions or pre-entered preferences using an affinity algorithm to match a preference to one or more product parameters, and from behavioristic factors, such as products with which the consumer has interacted. Assumed consumer preferences can be derived from parameters associated with an electronic kiosk (e.g., based upon what products are at the location, an ad campaign to which a consumer has or is likely to have been exposed, or the like). Product customization identifies a product that can be checked out by the consumer. Checking the product out may or may not include payment for rental (or borrowing) or sale (or gift).

The check-out engine 422 is intended to represent an engine that enables a consumer to check out a selected product. In a specific implementation, the check-out engine 422 includes a point-of-sale (PoS) terminal operated by an agent of a retail location. In an alternative, the check-out engine 422 is part of an e-commerce or m-commerce system that enables a consumer to check-out products at the electronic kiosk and/or online. A consumer may be able to purchase an item that is shipped to an address if the system is appropriately configured and is provided the address.

The following is an example of operation using FIG. 4 for illustrative purposes. A retailer or agent thereof provides content and parameters associated with advertising, providing information about, or otherwise showing off a retail space, which is stored in the customer datastore 402. The customer datastore 402 can also include information about other retail locations that are remote relative to an electronic kiosk, retail partners, and even retail competitors.

A brand owner or agent thereof provides content and parameters associated with advertising, providing information about, or otherwise showing product, which is stored in the product datastore 404. The product datastore 404 can include information about products available at a retail location in which an electronic kiosk is located, which can include products from different brand owners, but can also include information about some or all other products of a brand owner, related products, competing products, and the like.

An electronic kiosk can be located within a retail location, provided as a booth at a trade show, or otherwise made available to potential consumers in a locale. When not in consumer interaction mode, the electronic kiosk media presentation engine 406 can cause the electronic kiosk to enter a sleep mode; present a default script, such as a map of a retail location, music video, or other content; or present advertisements as deemed appropriate for the retailer or some other party with an ownership interest in the advertising space/resource, which may or may not include the aforementioned brand owner.

Consumer demographic, geographic, behavioristic, psychographic, and other parameters associated with known humans may or may not be available to the electronic kiosk at any given time because the electronic kiosk may be configured to avoid retaining personally identifying information, but such information is generally available in the cloud, e.g., on social websites, and within personal devices of potential consumers. The data that is at some point made available to the electronic kiosk is represented by the consumer datastore 408. Calendar, social network, and other associated data can also be useful, depending upon the capabilities of the electronic kiosk.

When in consumer interaction mode, the electronic kiosk ambiance engine 410 works with the electronic kiosk media presentation engine 406 to present a customized experience for a consumer. For example, when a consumer brings an article of clothing into an electronic kiosk to try it on, the electronic kiosk ambiance engine 410 can obtain information about the relevant article of clothing from the product datastore 404. To the extent any information is known about the consumer, the electronic kiosk ambiance engine 410 can also use the consumer datastore 408 to further customize the experience, such as by playing music the consumer likes, making suggestions around a theme within which the consumer is associated (e.g., a party to which the consumer has been invited that has a theme of some kind), comparing with articles of clothing friends have purchased, or the like. The amount of data in the consumer datastore 408 will depend upon how much a consumer wishes to share, how much work the electronic kiosk does to augment the data (e.g., by searching social media), and how much data the electronic kiosk wishes to access (e.g., it may be undesirable to attempt to obtain PII).

The electronic kiosk interactivity engine 414 detects stimuli at the electronic kiosk, which are interpreted and stored as detected interactions in the detected interaction datastore 412. The electronic kiosk ambiance engine 410 can adjust in accordance with detected interactions, such as commands to change music volume, display a “next” product in an interactive display, or the like. Interactions can also be used to trigger the associate summoning engine 418, the product customization engine 420, or the check-out engine 422.

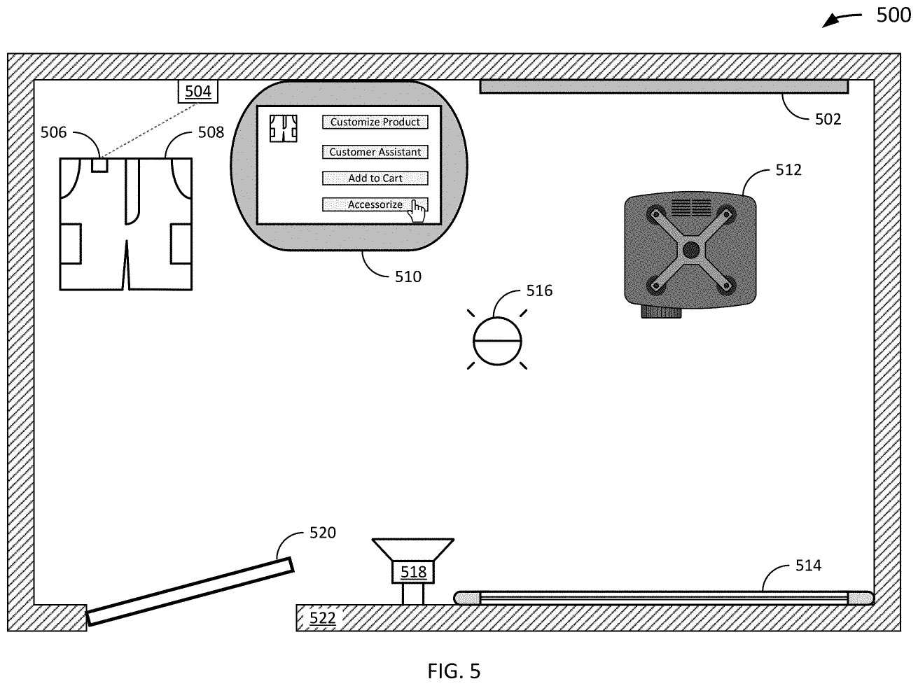

FIG. 5 depicts a diagram 500 of an example of an adaptive fitting room. An adaptive fitting room can be provided as part of a RaaS offering. The diagram 500 includes a mirror 502, a sensor 504, a product tag 506, a product 508, an interactive display 510, a projector 512, a projector screen 514, a light 516, a speaker 518, a door 520, and walls 522.

The mirror 502 is intended to represent a typical mirror found in a fitting room. In an alternative, the mirror 502 includes smart mirror functionality that allows the image to be modified to change the color of articles, provide a relevant background (e.g., a beach wedding if purchasing clothing for attendance at a beach wedding), detecting the consumer and, if applicable, articles of clothing to enable evaluation for fit, relevance, or other purposes, or the like.

The sensor 504 is intended to represent a type of sensor suitable for determining proximity to the product tag 506, such as through radio (e.g., RFID), IR, acoustics, or the like. In an alternative, there are multiple sensors with different stimuli-detecting functionality. For example, a sensor could detect movement (including gestures), temperature, sound (including voice recognition) or the like. In some implementations, the product 508 can be detected directly, as opposed to detecting a product tag that is assumed to be applicable to the product to which it is attached.

The interactive display 510 is intended to represent a device that enables a consumer to interact with the adaptive fitting room (the electronic kiosk of this example) through a graphical user interface. In a specific implementation, the interactive display 510 is a tablet computer configured for use in the electronic kiosk. In an alternative, the interactive display 510 is a personal device of the consumer who has navigated to an appropriate page, either via a browser or by utilizing an applicable app.

The projector 512 is intended to represent a device that projects media onto the projector screen 514. In an alternative, the projector screen 514 can be a painted wall. The light 516 is intended to represent a device that provides lighting of variable brightness and color to the electronic kiosk. The speaker 518 is intended to represent a device that provides music and other audio media to the electronic kiosk.

The door 520 and the walls 522 are intended to represent structures that can be used to define the area of the electronic kiosk (with ceiling and floor, not labeled, the volume can be defined).

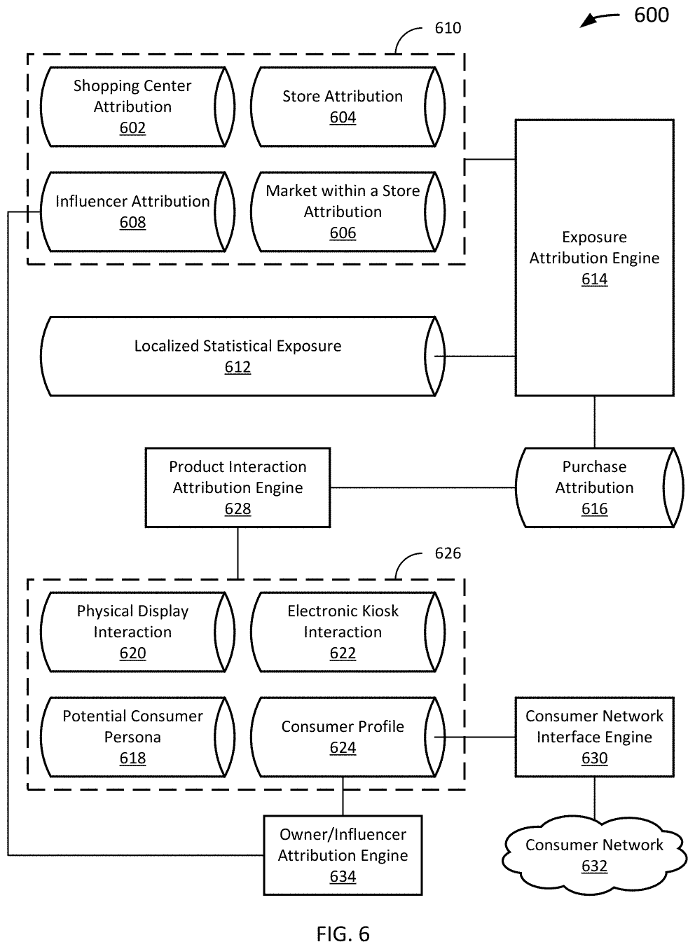

FIG. 6 depicts a diagram 600 of an example of an attributable interest determination system. The diagram 600 includes a shopping center attribution datastore 602, a store attribution datastore 604, a market within a store attribution datastore 606, and an influencer datastore 608, all of which can be characterized as a remote advertisement exposure datastore 610. The diagram 600 further includes a localized statistical exposure datastore 612, an exposure attribution engine 614 coupled to the remote advertisement exposure datastore 610 and the localized statistical exposure datastore 612, a purchase attribution datastore 616 coupled to the exposure attribution engine 614. The diagram 600 further includes a potential consumer persona datastore 618, a physical display interaction datastore 620, an electronic kiosk interaction datastore 622, and a consumer profile datastore 624, all of which can be characterized as a product interaction datastore 626. The diagram 600 further includes a product interaction attribution engine 628 coupled to the product interaction datastore 626 and the purchase attribution datastore 616, a consumer network interface engine 630 coupled to the consumer profile datastore 624, a consumer network 632 coupled to the consumer network interface engine 630, and an owner/influencer attribution engine 634 coupled to the consumer profile datastore 624.

The shopping center attribution datastore 602 is intended to represent data associated with evaluation of an advertising campaign directed at a shopping center in which a retailer is found. There are many techniques for evaluating advertising effectiveness, none of which is perfect. It is assumed some appropriate technique is used to establish a consumer purchase (in the future) can be traced back, at least in part, to a shopping center advertisement (or goodwill associated with the shopping center). It may be noted the shopping center advertisement or goodwill could draw a consumer to a shopping center, the consumer could interact with a product in a market, and the consumer could later purchase the product online. In such an instance, attribution may be limited by the amount of information available to the system. For example, if the consumer cannot be tracked from the shopping center to the market, the later online purchase can be accounted for, at best, statistically. The same is true if the consumer cannot be tracked from the market to the online purchase.

The store attribution datastore 604 is intended to represent data associated with evaluation of an advertising campaign directed at a store in which a product is available. Many of the same advertising campaign evaluation techniques as used to determine shopping center attribution can be used to determine store attribution, with the additional caveat that store attribution is often less localized. For example, a specific shopping center may be known locally, but Macy's is known worldwide. Also, obviously, stores sometimes stand alone, making shopping center attribution irrelevant in some instances.

The market within a store attribution datastore 606 is intended to represent data associated with evaluation of an advertising campaign directed at a market within a store where a product is made available. It may be noted that an entire store could employ RaaS, making the distinction between the store itself and a market within the store unnecessary (or multiple distinct markets could be housed within a store).

The influencer attribution datastore 608 is intended to represent data associated with evaluation of effectiveness of an influencer. Known techniques can be used to determine how much value a spokesperson or other influencer has for a brand. Influencers can be paid or unpaid. For example, a person may like to wear a particular brand of clothing but receive no compensation from the brand. Nevertheless, if may be desirable for a brand owner to know about influencers in case the brand owner wishes to express appreciation or take some other action. The reach of an influencer can very from a small circle of friends to mainstream. In this paper, a consumer who explicitly expresses an intent to purchase a product, or who indicates the product has been purchase, or who implicitly indicates interest in the product through use or other actions that can become known to others is considered an influencer. Of course, the degree of influence can be essentially zero on the lower end of the influence scale.

The localized statistical exposure datastore 612 is intended to represent data associated with evaluation of effectiveness of on-site advertisement or product placement. This data is distinguished from data that can be attributed to an individual. Typical evaluations of on-site advertisement include an evaluation of traffic flow near an advertisement and can include such parameters as linger. To the extent some form of individualization of traffic is possible, that is treated as potential consumer persona data, described later.

The exposure attribution engine 614 is intended to represent an engine that analyzes contents of the remote advertisement exposure datastore 610 and the localized statistical exposure datastore 612 to determine how much attribution is applicable to remote and localized advertising efforts and exposure that can be associated with a future purchase. That is, when a purchase is made, attribution can be made. This attribution is possible regardless of where a purchase is made, and even localized attribution is possible for online purchases if a consumer can be tied (even statistically) to the relevant location. However, if attribution includes product interaction, as described next, a more accurate attribution becomes possible.

The purchase attribution datastore 616 is intended to represent a datastore that allocates portions of attribution for various advertisements and exposures in association with a product purchase. The attribution may or may not be associated with compensation in accordance with allocated attribution.

The potential consumer persona datastore 618 is intended to represent a datastore of parameters associated with a human at a store. In this paper, a persona is a representation of a human for which personally identifiable information is either not available or not stored (for privacy-related purposes, typically). A persona can include, for example, demographic information (such as apparent age, apparent gender, apparent size, or the like), behavioristic information (such as traffic patterns of the human or the human's shopping cart, time spent lingering in front of a particular product, time spent using a personal device, or the like), or other anonymized information.

The physical display interaction datastore 620 is intended to represent a datastore of parameters associated with interactions between potential consumers and a product at a physical display associated with the product. Interaction between a persona and a product can represent an intersection between the potential consumer persona datastore 618 and the physical display interaction datastore 620. To the extent attribution of an interaction cannot be linked to a purchase, interaction attribution can be accomplished through statistical means, such as by considering the ratio of traffic (or linger) to number of purchases.

The electronic kiosk interaction datastore 622 is intended to represent a datastore of parameters associated with interactions between potential consumers and a product that has been brought (or physically or virtually) to an electronic kiosk at the electronic kiosk. In a specific implementation, the product is tracked from a physical display to the electronic kiosk or carried over virtually (e.g., through the use of QR codes or some other tag), which enables retention of physical display interaction in association with electronic kiosk interaction (and the retention of persona data, if applicable).

The consumer profile datastore 624 is intended to represent a datastore of parameters associated with a consumer. In a specific implementation, data from the potential consumer persona datastore 618 is stored in the consumer profile datastore 624 in association with the applicable consumer when the consumer becomes identifiable. It is possible for a consumer to purchase a product while retaining anonymity, such as be using cash, or to retain the equivalent of anonymity, such as by refusing to permit the store from retaining personal information even if a credit card is used. Even in such a case, a persona that can be determined to have interacted with a product is useful for attribution purposes, particularly if that persona can be credited with a purchase (as opposed to crediting personas statistically).

The product interaction attribution engine 628 is intended to represent an engine that analyzes contents of the product interaction datastore 626 to determine how much attribution is applicable to RaaS for facilitating interaction between a consumer and a product that leads to a future purchase, which is stored in the purchase attribution datastore 616. That is, when a purchase is made, attribution can be made. This attribution is possible regardless of where a purchase is made but can be particularly accurate if a consumer can be tracked from the interaction to, e.g., an online purchase.

The consumer network interface engine 630 is intended to represent an engine that connects a device of the electronic kiosk or a personal device of a consumer to the consumer network 632. The consumer network 632 is intended to represent one or more networks to which a consumer has access, such as a cellular network, a social network, or some other network. Of particular note to the system represented in this diagram 600 is that portion of the consumer network 632 that can become known to the product interaction attribution engine 628 for attribution purposes. As described elsewhere in this paper, the consumer network 632 could also be the repository of content that is downloaded to an electronic kiosk for reference (e.g., to wedding party details, to a calendar, to a friend's shopping cart or wardrobe, etc.) or ambiance (e.g., for music, language preferences, lighting preferences, etc.). To the extent such information is made available to the product interaction attribution engine 628, attributions can be updated to reflect influencers (e.g., if the consumer makes reference to a wedding party, the bride, groom, or wedding planner could be attributed). Such attribution becomes particularly straight-forward if the electronic kiosk is reserved for the consumer in advance.

The owner/influencer attribution engine 634 is intended to represent an engine that analyzes contents of the consumer profile datastore 624 to determine how much attribution is applicable to the consumer post-purchase and store an attribution value in the influencer attribution datastore 608 in association with the consumer. The consumer can be credited for posting information on the consumer network 632 for consumption by others, which can be traced back to the consumer as an influencer. For illustrative purposes, any such available information is treated as part of the consumer profile datastore 624, regardless of the physical location of the information.

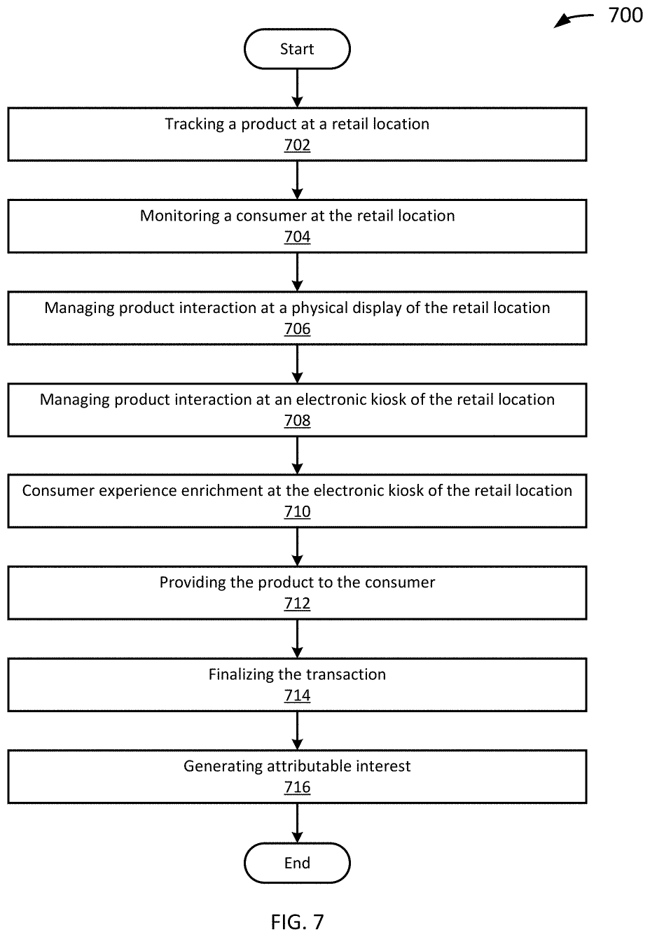

FIG. 7 depicts a flowchart 700 of an example of RaaS-integrated electronic kiosk interaction method. For illustrative convenience, the electronic kiosk is assumed to be an adaptive fitting room in a retail store. In the example of FIG. 7, the flowchart 700 starts at module 702 with tracking a product at a retail location. Product tracking can be accomplished with a product tracking engine, such as the product tracking engine 116 of FIG. 1 or the product tracking engine 202 of FIG. 2. In an adaptive fitting room implementation, a product datastore, such as the product datastore 204 of FIG. 2, is updated to indicate a product is in-store. The product datastore can include product parameters, such as cost, size, color, or the like.

The flowchart 700 continues to module 704 with monitoring a potential consumer at the retail location. Consumer monitoring can be accomplished with a consumer monitoring engine, such as the consumer monitoring engine 118 of FIG. 1. The amount of information known about a consumer can vary depending upon the willingness of a retailer to obtain information about the consumer and the willingness of the consumer to share information about themselves.

The flowchart 700 continues to module 706 with managing product interaction at a physical display within the retail location. Product interaction can be accomplished with a product interaction management engine, such as the product interaction management engine 120 of FIG. 1, or a retail location management engine, such as the retail location management engine 206 of FIG. 2. Product interaction includes product display, which can be in accordance with physical display configuration parameters as described with reference to the physical display configuration parameters datastore 208 of FIG. 2. Interaction with the product at a physical display represents an intersection between consumer and product tracking and can be accomplished by a physical display management engine, such as the physical display management engine 210 of FIG. 2. Such interaction can be stored in either or both of a product datastore, such as the product datastore 204 of FIG. 2, or a consumer datastore that is part of a consumer monitoring system.

The flowchart 700 continues to module 708 with managing product interaction at an electronic kiosk within the retail location. As mentioned previously, product interaction can be accomplished with a product interaction management engine, such as the product interaction management engine 120 of FIG. 1, or a retail location management engine, such as the retail location management engine 206 of FIG. 2. Product interaction at an electronic kiosk involves media presentation at the electronic kiosk, which can be in accordance with electronic kiosk configuration parameters as described with reference to the electronic kiosk configuration parameters datastore 212 of FIG. 2. Interaction with the product at the electronic kiosk represents an intersection between consumer and product tracking that may or may not have been continuous since the intersection at the physical display (and may or may not be with the same product), as described previously, and can be accomplished by an electronic kiosk management engine, such as the electronic kiosk management engine 214 of FIG. 2, which can include an electronic kiosk media presentation engine, such as the electronic kiosk media presentation engine 406 of FIG. 4; an electronic kiosk ambiance engine, such as the electronic kiosk ambiance engine 410 of FIG. 4; and an electronic kiosk interactivity engine, such as the electronic kiosk interactivity engine 414 of FIG. 4.

The flowchart 700 continues to module 710 with consumer experience enrichment at the electronic kiosk of the retail location. Consumer experience enrichment can include assistance, such as would be provided through an associate summoning engine, such as the associate summoning engine 418 of FIG. 4, and providing a consumer what they need to make a decision that matches their predilections, such as via a product customization engine, such as the product customization engine 420 of FIG. 4. Associate summoning can provide a consumer with conveniences while they consider options, such as by enabling the consumer to request an associate bring a variant product, bring refreshments, provide wardrobe advice, or to facilitate an RSVP (e.g., via an artificial agent) to an event while the consumer is at the electronic kiosk. Product customization can enable a consumer to change size, color, monogram, embroidery, or the like of a garment, or make other changes to parameters of garment or non-garment products. If AR or VR is used, software can make the changes to the product virtually and “put it on” the consumer. Other products or accessories can also be matched to a chosen product. For example, if a brand is sponsoring some aspect of the electronic kiosk, products associated with the brand can be offered as alternatives, options, or accessories; if a consumer is associated with a theme, such as a rock tour, thematic party, or wedding, products can be matched to the theme (e.g., rock band T-shirts, appropriate bridesmaid outfits, or the like) either by performing an analysis or by offering pictures, suggestions, shopping carts of friends or those with a similar profile such that the consumer can make educated decisions.

The flowchart 700 continues to module 712 with providing the product to the consumer. Providing the product to the consumer through sale, rental, gift, or other applicable transaction can be accomplished in accordance with point-of-sale parameters, such as described with reference to the point-of-sale parameters datastore 216 of FIG. 2, by a point-of-sale engine, such as the point-of-sale engine 218 of FIG. 2. Depending upon the implementation, a consumer may be able to check out the product at the electronic kiosk using a check-out engine, such as the check-out engine 422 of FIG. 4, which could enable the consumer to make an m-commerce transaction and take the product with them when they leave the retail location, enable the consumer to make an e-commerce transaction and have the applicable product shipped to some other location, send a shopping basket of selected items to a profile associated with the customer for later consideration, or communicate with a point-of-sale system that the consumer will be purchasing the product at a point-of-sale location that is not the electronic kiosk, to name a few options. Upon completion of the transaction, the product may be characterized as “sold” in this paper with the understanding some colloquial terminology is more apt in some cases (e.g., when the product is offered as a gift, when the product is rented, or the like).

The flowchart 700 continues to module 714 with finalizing the transaction. After a span of time, the length of which may depend upon a number of factors, the product is considered to be sold and not returned. Finalizing the transaction may be accomplished by a post-sale feedback engine, such as the post-sale feedback engine 220 of FIG. 2, which may consider feedback from any applicable source, including an artificial agent that determines the transaction has been finalized (or provides a probability the transaction has been finalized for statistical evaluation purposes). If explicit feedback is desired, a consumer could be asked to review products that were purchased, brought to a fitting room, or with which the consumer interacted at a physical display.

The flowchart 700 ends at module 716 with generating attributable interest. Attributable interest can be generated by an attributable interest engine, such as the attributable interest engine 130 of FIG. 1 or the exposure attribution engine 614, product interaction attribution engine 628, and owner/influencer attribution engine 634 of FIG. 6.

1. A system comprising:
a remote advertisement exposure datastore;
a localized statistical exposure datastore;
an exposure attribution engine coupled to the remote advertisement exposure datastore and the localized statistical exposure datastore;
a product interaction datastore;
a purchase attribution datastore;
a product interaction attribution engine coupled to the product interaction datastore and the purchase attribution datastore;
a consumer profile datastore;
a consumer network interface engine coupled to the consumer profile datastore;
an owner/influencer attribution engine coupled to the consumer profile datastore.

2. The system of claim 1 comprising a shopping center attribution datastore.

3. The system of claim 1 comprising a store attribution datastore.

4. The system of claim 1 comprising a market within a store attribution datastore.

5. The system of claim 1 comprising an influencer datastore.

6. The system of claim 1 comprising a potential consumer persona datastore.

7. The system of claim 1 comprising a physical display interaction datastore.

8. The system of claim 1 comprising an electronic kiosk interaction datastore.

9. The system of claim 1 comprising a consumer network coupled to the consumer network interface engine.

10. The system of claim 1 comprising an adaptive fitting room.

11. The system of claim 10 wherein the adaptive fitting room includes a mirror, a sensor, an interactive display, a projector, a projector screen, a light, and a speaker.

12. The system of claim 10 wherein the adaptive fitting room, in operation, includes a product tag and a product.

13. A method comprising:
tracking a product at a retail location;
monitoring a consumer at the retail location;
managing product interaction at a physical display of the retail location;
managing product interaction at an electronic kiosk of the retail location;
generating attributable interest.

14. The method of claim 13 comprising enriching consumer experience at the electronic kiosk of the retail location.

15. The method of claim 13 comprising providing the product to the consumer.

16. The method of claim 13 comprising finalizing the transaction.

17. A system comprising:
a means for tracking a product at a retail location;
a means for monitoring a consumer at the retail location;
a means for managing product interaction at a physical display of the retail location;
a means for managing product interaction at an electronic kiosk of the retail location;
a means for generating attributable interest.

18. The system of claim 17 comprising a means for enriching consumer experience at the electronic kiosk of the retail location.

19. The system of claim 17 comprising a means for providing the product to the consumer.

20. The system of claim 17 comprising a means for finalizing the transaction.
